(19) United States
(12) Patent Application Publication
(10) Pub. No.: US 2025/0305302 A1
(43) Pub. Date: Oct. 2, 2025

(54) MOLDED WINDOW WELL WITH IMPACT RESISTANT LIP

(71) Applicant: ROCKWELL, LLC, Springville, UT (US)

(72) Inventors: Vaughn Allen COOK, Mapleton, UT (US); David Wayne HOAGLAND, Provo, UT (US); Ryan Andrew LARSON, Spanish Fork, UT (US); Daniel Alejandro GUZMAN MORENO, Bosques de san Sebastian (MX); Eder Textli JUÁREZ, Zacatelco (MX); Bart Jan STORRS, Highland, UT (US)

(21) Appl. No.: 19/077,897

(22) Filed: Mar. 12, 2025

Related U.S. Application Data
(63) Continuation-in-part of application No. 29/937,811, filed on Apr. 17, 2024.
(60) Provisional application No. 63/572,000, filed on Mar. 29, 2024.

(51) Int. Cl. E04F 17/06; B29C 70/42; B29L 16/00

(52) U.S. Cl. CPC E04F 17/06; B29C 70/42; B29L 2016/00

(57) ABSTRACT

A window well formed of a fiber reinforced plastic, including a body having a plurality of ribs interposed between a plurality of wall surface portions. The window well includes flanges on either side of the body, with flange cut-out portions at a top of each flange. A plurality of corrugations are provided in a curved top lip of the window well for improved impact resistance. The window well may also include one or more of the following features: integrated stacking platforms along the flange to reduce “wedging” when storing stacked window wells, mating features in the top and bottom of the body to allow vertical stacking attachment of one window well to another to form a taller window well, rib gussets, integrated forklift supports, and/or an additional pair of smaller ribs along the flat bottom portion of the window well to facilitate ultrasonic welding of one window well to another.

### CROSS-REFERENCE TO RELATED APPLICATIONS

This Application claims priority to and the benefit of U.S. Provisional Patent Application Ser. No. 63/572,000, filed Mar. 29, 2024, and titled “MOLDED WINDOW WELL WITH IMPACT RESISTANT LIP,”. This application is also a continuation-in-part of Design Patent Application Serial No. 29/937,811, filed Apr. 17, 2024, titled “WINDOW WELL WITH LIP”, each of which is herein incorporated by reference in its entirety.

Each of applicant's previous U.S. Pat. Nos. 7,966,776; 11,697,252; 11,834,849; 11,834,850; 11,725,400; D931,497; and D931,498 is incorporated herein by reference in its entirety.

### BACKGROUND

### Technical Field

This disclosure generally relates to window wells and associated manufacturing processes for forming such window wells. More specifically, the present disclosure relates to window wells including improved structural features, as well as processes for charge-molding such window wells from a thermoplastic material, e.g., with fiber reinforcement.

### Related Technology

A window well is one type of a building component that can be used to hold back dirt and other material from a window that is below ground level. A typical window well is embodied as a U-shaped wall formed out of metal. One purpose of a window well is to let natural light into basement windows, while also providing an access point for entry/escape, should such be necessary. Window wells are often attached directly to a building structure and are visible from both the inside and outside of the building structure. Additionally, window wells must be strong enough to hold back and retain backfill soils without deflecting.

Many window wells are made of steel or a similar metal, which makes them relatively heavy and difficult and expensive to transport. Additionally, metal window wells can be easily damaged during transportation and installation. Even after installation, a metal window well can be damaged. For instance, a window well can be impacted by other devices after the window well has been installed. When a damaged window well needs to be replaced, it can be an expensive and time intensive process to excavate and replace an installed window well.

Additionally, since window wells are exposed to the elements, they can become corroded and rust (depending on their material composition). Even when not corroded, metal window wells can be somewhat unattractive. Furthermore, it is difficult to make a metal window well look like a natural material or be aesthetically pleasing.

Some window wells are manufactured out of plastic materials, which makes them easier to apply an aesthetic texture to. However, the improved aesthetics often come at a cost of sacrificing durability and strength. In particular, many existing window wells manufactured out of currently employed plastic materials are typically not strong enough to compete with metal window wells because the types of plastic that are suitable for injection molding or rotomolding (the typical processes used for manufacturing plastic window wells) are not compatible with manufacture of a layered or reinforced plastic material.

Applicant's patents noted above address some such issues. Even with such improvements, there is still a continuing need for further improvements within available window well technology.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Disclosed embodiments relate to window wells composed of a fiber reinforced plastic. In an embodiment, the window well may include fibers that are omnidirectional (e.g., randomly oriented) relative to other fibers in the thermoplastic. Additionally, at least some of the included fibers may have a length greater than 5 mm, greater than 10 mm, greater than 12 mm, greater than 15 mm, greater than 20 mm, greater than 25 mm, greater than 30 mm, greater than 35 mm, or greater than 40 mm.

In some embodiments, the window well is composed of a fiber reinforced plastic, such as a thermoplastic, where the window well includes a body having a plurality of ribs interposed between a plurality of wall surface portions. Additionally, each rib is positioned between two different wall surface portions. Each rib may be defined by a varying height and a varying depth (i.e., the height and/or depth changes along the length of the rib, from one end to the other). Furthermore, in some embodiments, the wall surface portions, ribs, and other portions of the body of the window well can have a varying thickness that varies from a minimal thickness of less than 3 mm to a maximum thickness of greater than 5 mm.

A general procedure for forming the present window wells may include (1) heating a fiber reinforced plastic or thermoplastic material (e.g., one or “charges” of the plastic or thermoplastic material) to more than 130° F.; (2) positioning the fiber reinforced thermoplastic material, within a mold; (3) optionally positioning one or more veils (e.g., fabric veils to provide color, pattern, texture or the like) onto the fiber reinforced thermoplastic material; and (4) compressing the fiber reinforced thermoplastic material within the mold with a pressure of greater than 200 psi. In some embodiments, the thermoplastic material is heated to more than 150° F., more than 180° F., more than 200° F. more than 225° F. more than 250° F., or more than 385° F. either prior to or during the compression. Additional details relative to the use of optional veils, as well as other details, are included in Applicant's patents already incorporated by reference.

In an embodiment, A window well is provided composed of a fiber reinforced plastic material, the window well can include a body having a plurality of ribs interposed between a plurality of wall surface portions, each rib being positioned between two different wall surface portions. In an embodiment, the ribs may be defined by a varying height and/or varying depth. The window well can include two or more flange cut-out portions, where the flange cut-out portions are located at a top of the body, within each flange, with a first flange cut-out portion located on one side of the body (in one attachment flange) and a second flange cut-out portion located on another side of the body (in another attachment flange). The window well further includes a plurality of corrugations located on a top lip of the window well. Such corrugations and flange cut-out portions may aid in increasing impact resistance along the lip and top of the flanges of the window well, which portions are often subjected to unintended blows (e.g., inadvertently dropping a sheet of plywood or OSB or other object on the top of the window well).

Another embodiment is directed to a window well composed of a fiber reinforced plastic material, the window well including a body having a plurality of ribs interposed between a plurality of wall surface portions, each rib being positioned between two different wall surface portions. The ribs may be defined by a varying height and/or a varying depth. The window well may also include a plurality of integrated stacking protruding members, wherein each of the integrated stacking protruding members is located on a side of the body located between sets of adjacent ribs, the integrated stacking protruding members extending from a flange of the window well. Such stacking members may extend outwardly from the flange, providing a platform to reduce “sticking” that may otherwise occur when stacking window wells one top of another (face-to-face) during storage and transportation. Such stacking members make it easier to remove one window well from such a stack of stored window wells, without the window wells sticking to one another. Such a window well may alternatively or additionally include a pair of integrated forklift supports, wherein the pair of integrated forklift supports are located so as to extend from a lower most rib of the window well, towards a bottom of the window well body. Such forklift supports can be positioned at opposing ends of a front face of the body, to provide a reinforced surface for engagement of forklift tines, when picking up one or more window wells (e.g., a stack of window wells) with a forklift.

Another embodiment is directed to a window well composed of a fiber reinforced plastic material including a body having flanges and a plurality of ribs interposed between a plurality of wall surface portions, each rib being positioned between two different wall surface portions. In an embodiment, the ribs may be defined by a varying height and/or depth. The flanges on either side of the window well can be configured with mating portions where the mating portions include top mating portions located on each side of a top portion of the flanges of the body, as well as bottom mating portions located on each side of a bottom portion of the flanges of the body. The bottom mating portions can be configured to mate with a second top mating portion at a top portion of the flange of a second window well body. This allows a manufacturer to produce one or more shorter window wells, which can be attached to one another, to produce taller window well products. The ability to produce such a taller window well, without needing a significantly larger mold, is particularly advantageous. In an embodiment, the two shorter window wells may be ultrasonically welded to one another, to produce a taller window well. For example, exemplary shorter window well sizes may include a 24 inch tall size, and a 36 inch tall size. Such a configuration allows attachment of two or more window wells, of either size, to produce a wide variety of height window wells (e.g., a 48 inch height from two 24 inch window wells, a 60 inch height from a 36 inch and 24 inch size, a 72 inch height from two 36 inch sizes, or an 84 inch height from a 36 inch size, and two 24 inch sizes, etc.).

Another embodiment is directed to a method of top-to-bottom vertical stacking and attachment of a first window well and a second window well to one another. Such a method includes providing a first window well, wherein the first window well includes flanges on either side of the first window well, such flanges being configured with mating portions. The mating portions include top mating portions located on each side of a top portion of the flanges of the body of the first window well. The method further includes providing a second window well, wherein the second window well includes flanges on either side of the second window well, such flanges being configured with mating portions. The mating portions of the second window well include bottom mating portions located on the sides of a bottom portion of the flanges of a body of the second window well, the bottom mating portions being configured to mate with the top mating portions of the first window well. The method further includes mating the top mating portions on the first window well with the bottom mating portions on the second window well, and welding or otherwise joining the first window well to the second window well (e.g., through ultrasonic welding).

Another embodiment is directed to a method of manufacturing a window well, the method including heating a mold to a temperature of greater than 130° F., greater than 150° F., greater than 180° F., greater than 200° F., greater than 225° F., or greater than 250° F., positioning one or more charges of a fiber reinforced plastic or thermoplastic material within the mold, and compressing the charge of fiber reinforced thermoplastic material within the mold with a pressure of greater than 200 psi. In an embodiment, the charge of fiber reinforced plastic or thermoplastic material is not in the form of a sheet.

In any of the described embodiments the ribs may be defined by a non-uniform, varying height and/or depth.

In any of the described embodiments the body may include a varying wall thickness.

In any of the described embodiments the varying wall thickness of the body may be thicker at a peak of the ribs as compared to the wall surface portions.

In any of the described embodiments the varying wall thickness of the body may be thicker near the top lip of the window well as compared to the wall surface portions.

In any of the described embodiments the spacing between each rib in the plurality of ribs may include a varying vertical height and each rib in the plurality of ribs may include a varying depth.

In any of the described embodiments the varying vertical height may be parallel to a major face of the body and the varying vertical height of the plurality of ribs may include a smaller height in a center of the body and a greater height at ends of the body.

In any of the described embodiments the window well may further include one or more pairs of rib gussets, wherein each pair of rib gussets is associated with and extends from a given rib.

In any of the described embodiments the associated rib may be located between a first gusset in the pair of gussets and a second gusset in the pair of gussets.

In any of the described embodiments the window well may further include one or more, or two or more additional ribs located at a bottom portion of the body, wherein the additional ribs run parallel to the plurality of larger body ribs located above such additional ribs.

In any of the described embodiments the window well may further include a plurality of integrated stacking protruding members, wherein each integrated stacking protruding member is located on a side of the body located between sets of adjacent ribs, the integrated stacking protruding members extending from a flange of the window well.

In any of the described embodiments the window well may further include a pair of integrated forklift supports, wherein the integrated forklift supports are located so as to extend from a lower most rib of the window well, towards a bottom of the window well body, the integrated forklift supports being positioned at opposing ends of a front face of the body.

In any of the described embodiments, flanges on either side of the window well may be further configured with mating portions, comprising top mating portions wherein the top mating portions are located on each side of a top portion of the flanges of the body, and bottom mating portions wherein the bottom mating portions are located on each side of a bottom portion of the flanges of the body, the bottom mating portions being configured to mate with a second top mating portion at a top portion of the flange of a second window well body.

In any of the described embodiments the window well further may include two or more flange cut-out portions, wherein the two or more flange cut-out portions are located at a top of the body with a first flange cut-out portion located on one side of the body and a second flange cut-out portion located on another side of the body.

In any of the described embodiments, the window well may further include a plurality of corrugations or other regions of varying thickness within the top lip of the window well. In any of the described embodiments, such corrugations may be in the exterior facing surface of the top lip of the window well (i.e., facing the back-filling soil). The opposite interior facing surface of the top lip of the window well may be substantially smooth.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail using the accompanying drawings in which:

FIG. 1 illustrates an example embodiment of an installed window well.

FIGS. 2A and 2B illustrate a top-down perspective and bottom-up perspective views respectively of the window well of FIG. 1.

FIGS. 3A and 3B illustrate a front (interior) perspective view and back (exterior) perspective view, respectively, of the window well of FIG. 1.

FIGS. 4A and 4B illustrate side perspective views of the window well of FIG. 1.

FIGS. 5A and 5B illustrate a top perspective view and a bottom perspective view, respectively of the window well of FIG. 1.

FIG. 6 illustrates another perspective view of the window well of FIG. 1 with emphasis on certain features.

FIGS. 7A through 7D illustrate close-up views of various features of the window well of FIG. 6.

FIG. 8 illustrates a close-up view of a side of the window well of FIG. 1.

FIGS. 9A and 9B illustrate a top-down perspective view and a bottom-up perspective view, respectively, of two window well segments, connected one atop the other, to create a taller window well.

FIGS. 10A and 10B illustrate an example of how the two window well segments may interconnect to one another.

FIGS. 11A and 11B illustrate close-up views of two example window well segments interconnecting, stacked one atop the other.

FIGS. 12A through 12C illustrate an example view of the top lip corrugations and side views of such an exemplary window well.

FIG. 12D illustrates a cross-sectional or side view, showing how the two window well segments interconnect to one another.

FIG. 13 illustrates exemplary additional notches found at the bottom of an example window well, providing increased surface area for ultrasonic bonding as one window well segment is attached over another, to form a taller window well.

FIGS. 14A-14D schematically illustrate an exemplary method for charge molding the window well from a plurality of drapable fiber-reinforced thermoplastic material charges.

### DETAILED DESCRIPTION

Before describing various embodiments of the present disclosure in detail, it is to be understood that this disclosure is not limited to the parameters of the particularly exemplified systems, methods, apparatus, products, processes and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed invention. In addition, the terminology used herein is for the purpose of describing the embodiments and is not necessarily intended to limit the scope of the claimed invention.

Furthermore, it is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition.

Additional ranges may be defined between any two values described herein as exemplary.

Any headings and subheadings used herein are for organizational purposes only and are not meant to be used to limit the scope of the description or the claims.

### I. Overview of the Process for Charge Molding Thermoplastic Window Wells

Embodiments disclosed herein relate to window wells that are manufactured out of fiber reinforced thermoplastic materials.

In some embodiments, the window well has a generally U-shaped body comprising a plurality of ribs and wall surface portions. Each one of the ribs is interposed between two different wall surface portions. It should be noted that the ribs increase the rigidity of the window well while keeping the weight of the window well low. Additionally, the window well typically includes substantially planar flanges that are used to securely attach the window well to the corresponding building structure (e.g., adjacent the window).

Additionally, in some embodiments, one or more fabric veils can be used to enhance aesthetic characteristics of the window well, e.g., as described in U.S. Pat. No. 11,834,850, herein incorporated by reference. For example, such a fabric veil can be placed in the mold either above or below the thermoplastic material (e.g., charges or sheets of such material). Therefore, when the thermoplastic material and veil are compressed by the molds, the fabric veil is embedded into the thermoplastic material and creates the outer layer of the window well. This additional outer layer can provide an extra layer of UV and other protection as well.

Such fabric veils can enhance the aesthetic qualities of the window well. For example, a pattern can be printed onto the fabric veils. Thus, when the fabric veils are compressed into the thermoplastic material, the patterns of the veils become embedded to the outside surface of the window well.

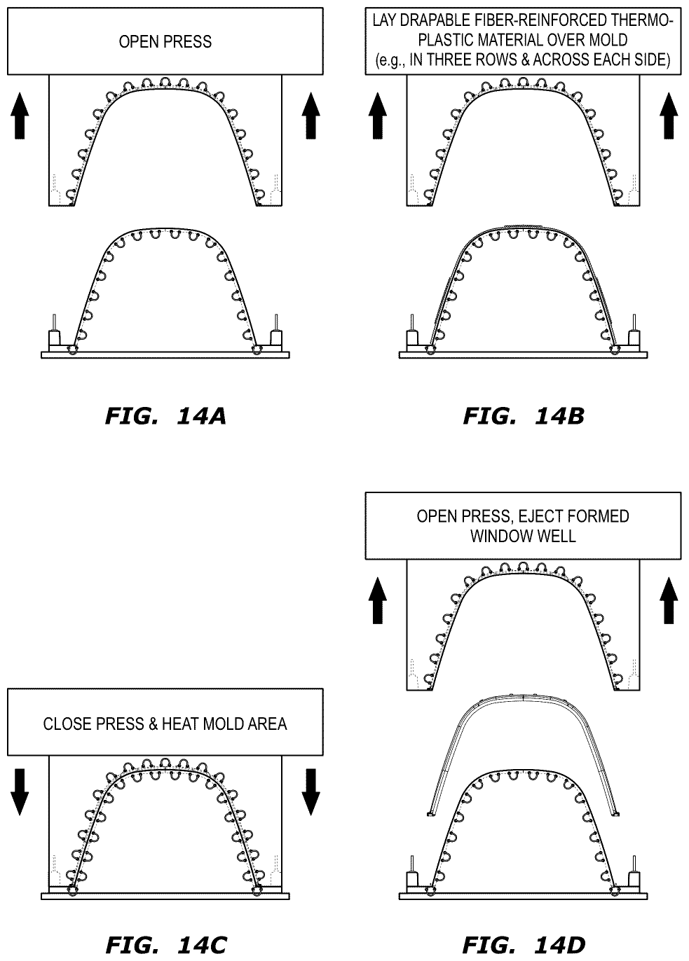

The presently contemplated embodiments may employ compression charge molding, rather than thermo-stamping. Rather than employing a sheet of fiber reinforced thermoplastic material, which is inserted into a mold (really a stamping mold), the present embodiments may employ charges (e.g., drapable, heat softened sections) of the thermoplastic material that may not be in sheet form, but are placed in the mold in an already preheated, softened state, as elongate thin strips of such material. For example, such material charges may be drapable elongate strips, not sheets (as they have substantially no rigidity), which are placed within a bottom half of the mold. By way of example, from 4-6, (e.g., 5) such material charges may be draped over the bottom half of the mold. The top half of the mold may then be lowered, compressing the material charges within the mold, causing the softened thermoplastic material to fill the void within the mold, and assume the desired shape of the window well being compression molded. The mold may remain closed and compressed for about 30 to about 60 seconds, or from about 35 to about 55, or from about 40 to about 50 seconds. Such an exemplary method is illustrated in FIGS. 14-16.

### II. Technical Benefits and Advantages

The disclosed embodiments increase the strength and durability of the window well, particularly the lip portion of the window well, which is otherwise often the most likely portion of a window well to be damaged. The present window wells are also shown as including additional various features that improve strength or handling relative to other portions of the window well. For example, features may be provided to improve ease of stacking stored window wells one over another in a “nested” arrangement, while ensuring that individual window wells are easily removable from such a nested arrangement, rather than sticking to one another. Specific mating features may be provided adjacent the top lip portion of such window wells to allow stacking one window well atop another window well, not for storage, but to increase the overall height associated with a given window well (e.g., which allows the window wells to be molded at a relatively reduced height, and then attaching two such window well segments together, to achieve a desired greater height). Such a configuration is advantageous, as costs for molding equipment increase exponentially with increasing size. By molding two smaller window well sections which can be ultrasonically or otherwise welded or attached together, costs can be significantly decreased, while still providing excellent strength. Another included feature may facilitate movement of one or more window wells (e.g., a stack of several such window wells, nested within one another) by the tines of a forklift, while minimizing risk of damage to such window wells by the forklift tines. Such are just a sampling of some of the features described herein, any combination of which can be included.

### III. Exemplary Lightweight and Durable Window Wells

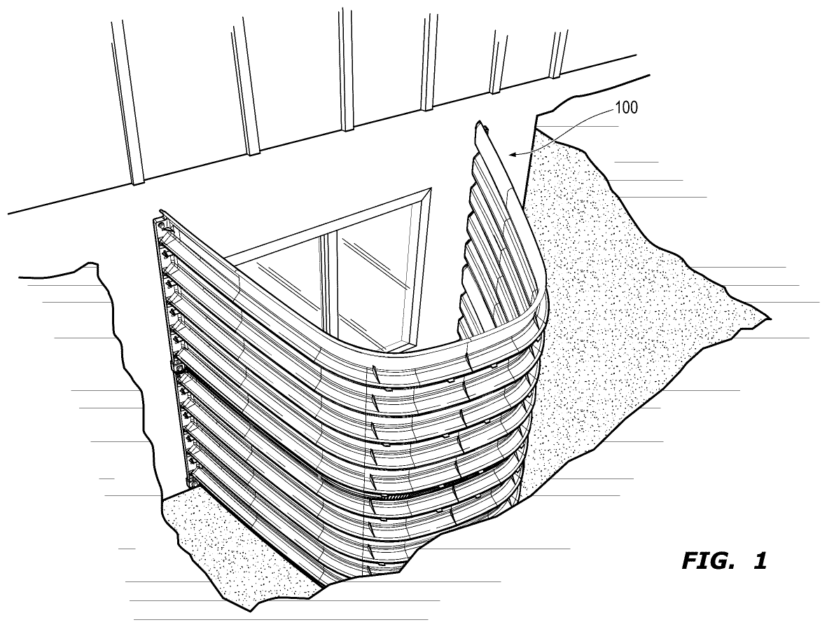

FIG. 1 illustrates a perspective view of an exemplary embodiment of a lightweight and durable window well 100 in an installed position. As shown, the window well 100 is attached to a structure, such as a home, and dirt is filled in around the window well 100. In some embodiments, the window well 100 is formed as a unified single piece structure. In other embodiments, the window well 100 may comprise multiple smaller window well segments that are attached to one another (e.g., one stacked on top of the other) to form a single window well. More specific features of the window well 100 are described in more detail below.

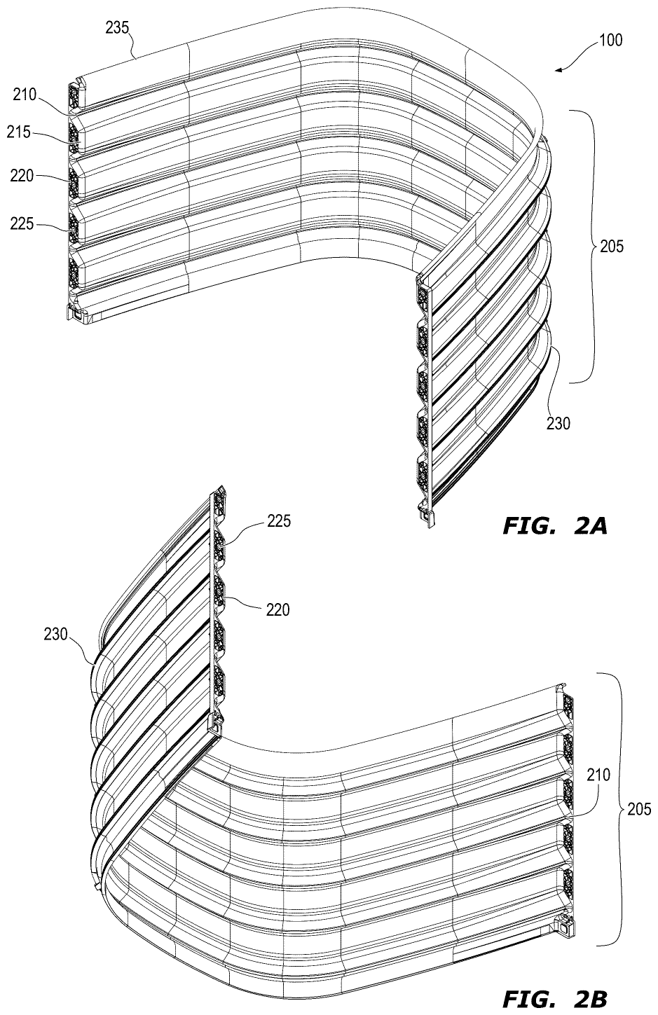

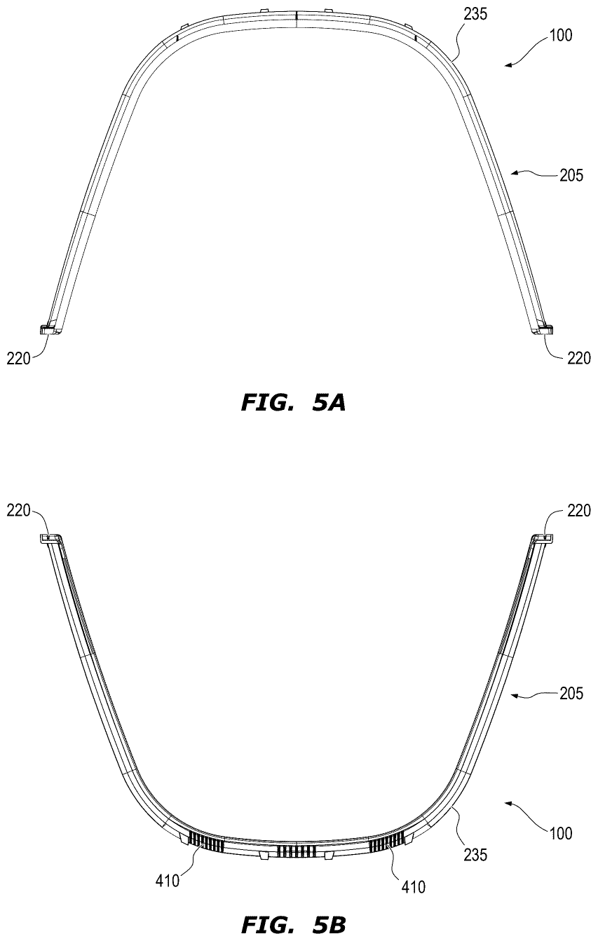

FIGS. 2A through 5B illustrate various perspective views of window well 100. In the Figures, the body 205 of the window well 100 is a generally U-shaped wall. However, alternative embodiments may have a body that is generally box shaped, V shaped or otherwise. Furthermore, it should be noted that the body can be a wall of any shape that retains backfill soil (e.g., square, rectangular or circular/curved shaped).

As shown in the Figures, the body 205 of the window well has grooves 210 running along the interior surface of the window well, with respective and corresponding ribs 230 running along the exterior surface of the window well. Wall surface portions 215 are positioned between sets of grooves 210. In some embodiments, the number of grooves, respective ribs, and wall surface portions vary based on the desired height of the window well. In other words, some embodiments may include more or less grooves and wall surface portions. Further details of such grooves 210, respective ribs 230, and surface portions 215 are provided hereafter, as well as in Applicant's previous patents, already incorporated by reference.

The lightweight and durable window well 100 also has substantially planar flanges 220 on each side. The flanges 220 are the portions of the window well which contact the building structure being attached to and are disposed on terminal ends of the window well 100 as shown. The planar flanges 220 have attachment holes 225 which facilitate installation of the lightweight and durable window well 100 (i.e., facilitate attaching the window well 100 to a home foundation or similar structure).

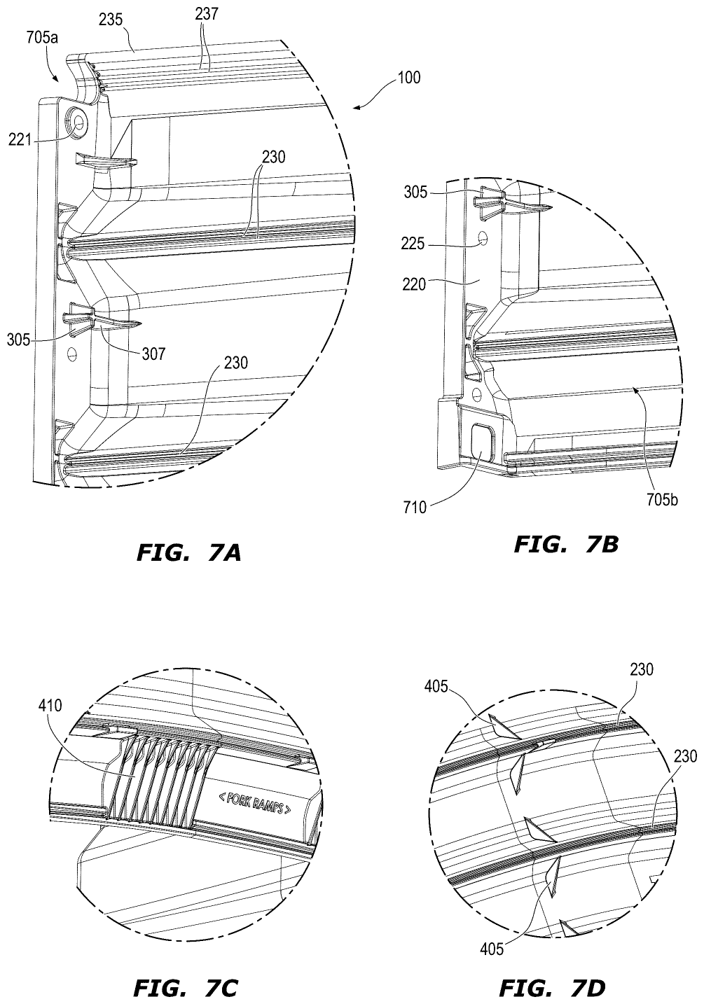

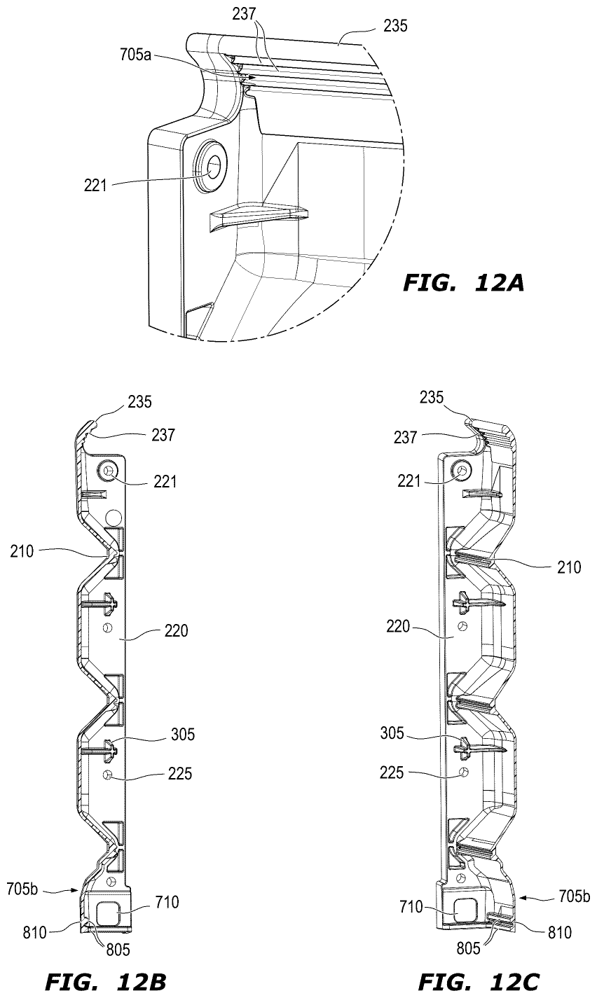

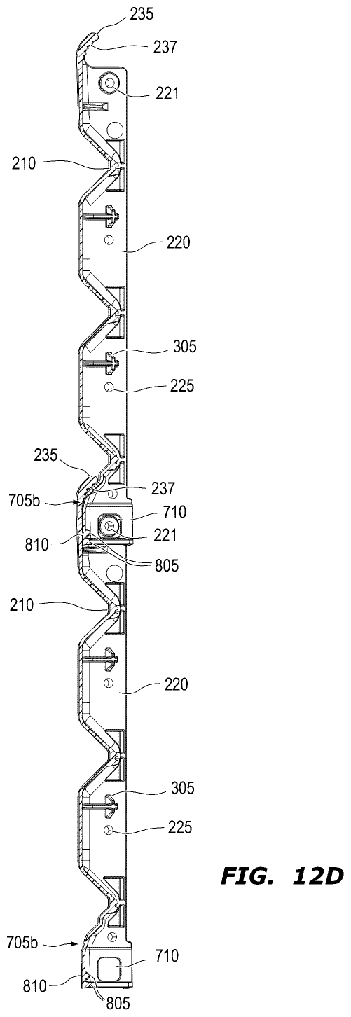

The window well 100 advantageously includes a top lip 235 that is particularly configured, for improved impact resistance. The top lip 235, in some embodiments, includes corrugations. The corrugated top lip 235 adds additional impact absorption through the ability to dissipate energy associated with objects (e.g., a sheet of plywood, other lumber, other objects, etc.) impacting the top lip 235. The particular configuration of the top lip 235 improves impact absorption, minimizing or preventing damage to the window well 100 once installed, as well as during transportation, storage and installation. FIGS. 7A and 12A, described in further detail below, illustrates a close-up view of the impact resistant top lip 235, including corrugations 237.

The attachment holes 225 allow the lightweight and durable window well 100 to be fastened to a structure using a screw or a bolt, e.g., and an accompanying nut. The attachment holes can be placed every 1 cm, 2 cm, 3 cm, 4 cm, 5 cm, 6 cm, 7 cm, 8 cm, 9 cm, 10 cm, 15 cm, 20 cm, 30 cm or more than 30 cm apart, according to need or preference. Additionally, the size and shape of the holes can vary to allow for a variety of fasteners. It should be noted that some embodiments do not include attachment holes. In embodiments without attachment holes, a user can add custom placed holes during the installation (e.g., by using a drill).

The attachment holes 225 also help in the transportation of the lightweight and durable window well 100. For example, the attachment holes 225 can be used to align, stack or secure the window wells while the window wells are being transported. Additionally, more material/thickness can be positioned at the flanges 220 to increase the strength of the flanges 220, while also reducing the amount of material in the rest of the window well, thereby reducing the overall weight of the window well. The top lip 235 may similarly be thickened, for increased strength and impact resistance.

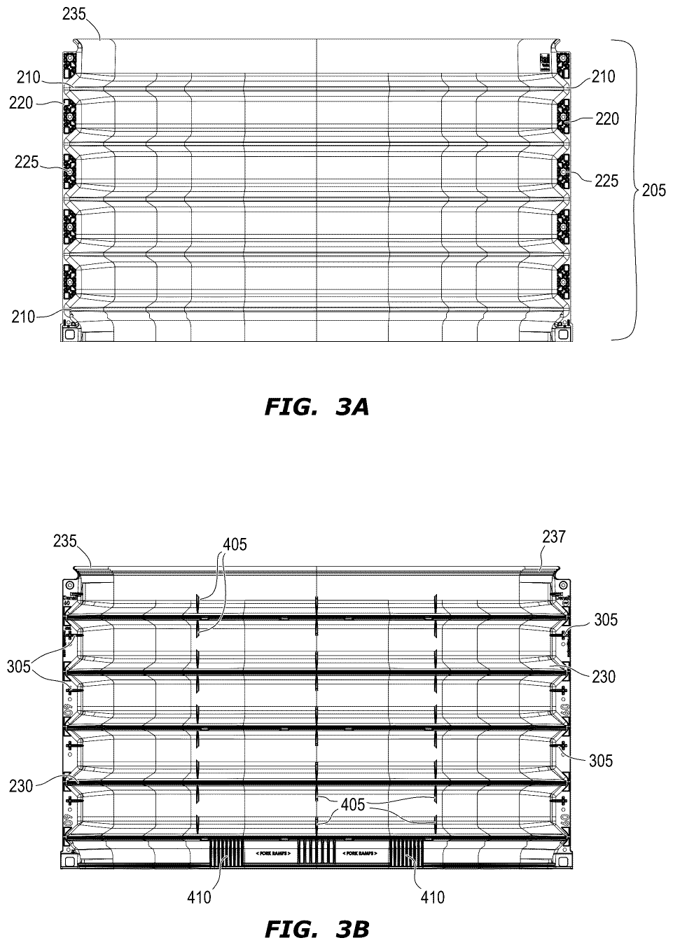

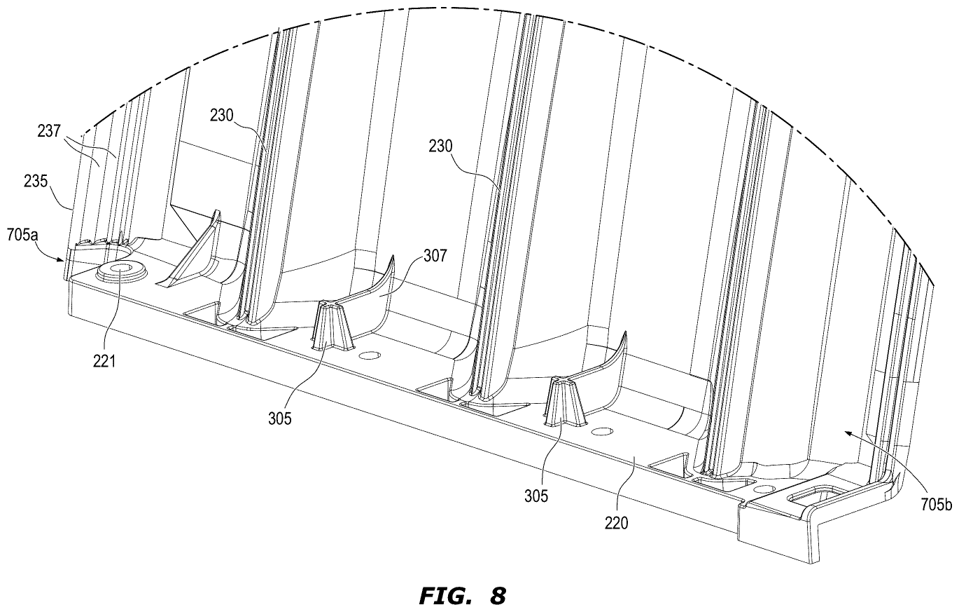

Additionally, to improve transportation and stacking of multiple window wells 100, some embodiments include an integrated stacking protruding member 305 on the flange 220, shown in FIG. 3B. A close-up view of such is perhaps best seen in FIGS. 7A-7B and FIG. 8. The integrated stacking protruding member 305 helps in controlling the spacing between window wells 100, in particular, when the window wells 100 are stacked on a pallet. The integrated stacking protruding member 305 acts as something of a stop, helping to avoid multiple window wells 100 becoming wedged together resulting in difficulty separating the window wells from one another, during storage. Further, the integrated stacking protruding member 305 provides increased stiffness at the flanges 220 by tying the flange 220 into the body 205 with the illustrated gusset portion 307, as shown (see FIG. 8). As shown, the stacking protruding member 305 may be configured as a platform, extending or projecting from the exterior face of the flange 220. It is also advantageous that this (and many of the other features described herein) is included on the exterior face of the window well, so as to provide the noted benefits, without interfering with the aesthetics of the interior face of the window well (as the interior face is seen once installed, and the exterior face is covered by soil).

The grooves 210 and associated ribs 230 can have a taper, as shown in FIGS. 3A-3B. The rib and groove taper further allows for improved stacking and nesting of multiple window wells 100 as the ribs of one window well are nested into the grooves of an adjacent stacked window well. This is due to the fact that the taper allows more window wells 100 to be stacked onto a shipping pallet or other container, to reduce shipping costs.

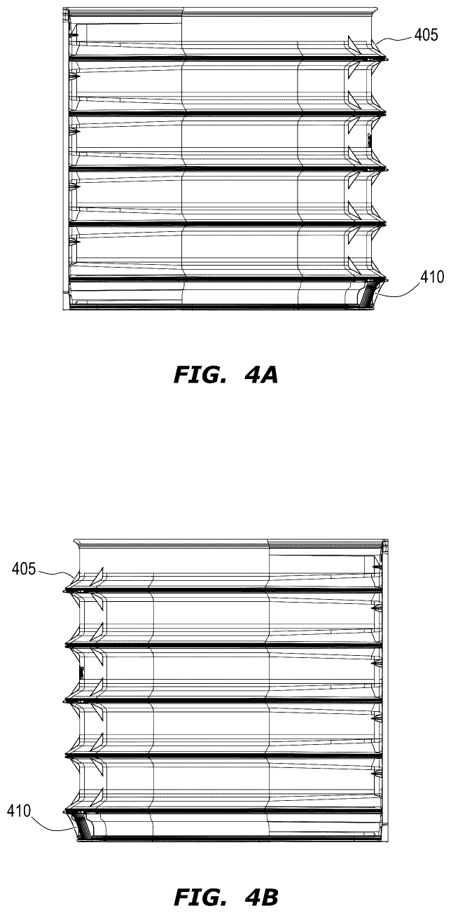

It should be noted that the ribs 230 and corresponding grooves 210 increase the stiffness and strength of the window well. It will be appreciated that the ribs 230 and grooves 210 are opposite sides of the same feature (i.e. the groove describes the front/interior surface while the rib describes the back/exterior surface of the same feature). In some embodiments, the ribs 230 include rib gussets 405, shown in FIG. 4A. The rib gussets 405 support the ribs 230 during production. For example, when the window well is still warm, when coming out of the mold, and during cooling, the corrugated nature of the window well (with the series of grooves, separated by wall surface portions) tends to collapse to some degree, like an accordion when cooling, if such gussets 405 are not present. It will be appreciated that the gussets 405, like the integrated stacking protruding member 305, are located on the exterior face of the window well, so as to be largely or entirely hidden by soil, during typical use after installation.

As shown in FIGS. 3B, 4A, and 4B, the window well 100 can further include integrated forklift supports 410. The forklift supports 410 reduce damage when the window well 100 is picked up using a forklift by avoiding the forklift tines otherwise hitting and damaging the bottom portions of the window well 100. In other words, the forklift supports 410 act as a ramp against which the forklift tines can engage, to avoid damage to the window well 100 as one or a stack of window wells are picked up, even where such may not be stacked on a pallet. It will be apparent that in such a configuration, the window well or stack of window wells may be positioned with the U-shape opening oriented upright, with the forklift support ramps 410 positioned adjacent the ground. The spacing of the forklift supports may be provided to correspond to typical tine spacing of a forklift (e.g., from about 36 to about 50 inches, such as about 43 inches).

The height of the body 205 of the window well 100 may vary to accommodate different needs and preferences, for example from 2 feet to 10 feet, from 3 feet to 7 feet, such as 4 feet, 5 feet, 6 feet, or 7 feet. Likewise, the width (i.e., the distance between the two opposite planar flanges) and the depth (i.e., the distance from the front of the planar flanges to the furthest point on the back of the ribbing) of the body 205 of the window well 100 may vary to accommodate different needs and preferences. As noted previously, it may be advantageous to mold the window well in 2 relatively short segment heights, such as 24 inches and 36 inches. As many (typically most) window wells will need to have a height greater than 36 inches, this can be achieved by ultrasonically welding, or otherwise attaching two or more such window well segments to one another, one atop the other. For example, two 24 inch segments can be used to form a 48 inch window well, a 36 inch and 24 inch segment can be used for form a 60 inch window well, two 36 inch segments can be used to form a 72 inch window well and two 24 inch segments and a 36 inch segment can be used to form an 84 inch window well. The 24 inch and 36 inch segments may be nominal, as some overlap may typically be provided, when attaching the two adjacent segments together (i.e., a 24 inch segment may provide a 24 inch height, but is actually taller than 24 inches, due to the overlap height).

In some embodiments, the body 205 has a variable wall thickness. For example, the wall thickness may be substantially constant throughout the window well except at the top lip 235 and the ribs/grooves 230/210. At these portions, the wall thickness may be relatively thicker than other adjacent portions of the body 205. In an embodiment, the flange 220 may also be thickened. By way of example, most of the body may have a relatively uniform thickness of about 2 to 5 mm, such as about 3.5 mm. Thickened portions may have a greater thickness, e.g., such as at least 5 mm, such as 5-6 mm.

The window well 100 can include one or more four directional indicators to facilitate proper placement during installation by helping a user correctly orient the window well 100. Such indicators may also facilitate proper orientation during storage and shipping. For example, in some embodiments, the window wells can be stored more compactly if all the window wells in storage have the same orientation.

Such directional indicators can be molded, stamped or printed into or on the surface of the window well 100. By way of example, such directional indicators could include a directional arrow and the word “UP.” Other configurations will of course be apparent to those skilled in the art.

The window well 100 can be formed of various materials, such as a thermoplastic composite with fiber reinforcement. It should be noted that some embodiments are made of polypropylene with relatively long reinforcing fibers. Such long fibers are typically incompatible with injection molding. For example, the length of such fibers may vary widely, but in an embodiment, may be from about 0.75 inch to about 1 inch. Longer and shorter fiber lengths are of course possible, e.g., as described in Applicant's earlier patents, already incorporated herein by reference. Various exemplary thermoplastic materials are also described in such earlier patents, already herein incorporated by reference.

In many instances, the reinforced thermoplastic is lighter and more durable to typical environmental conditions than traditional window well materials, such as metal and conventionally used plastics. For example, the reinforced thermoplastic material is more UV resistant and rust/corrosion resistant than traditional materials used to manufacture window wells. The reinforced thermoplastic material also performs well at low temperatures and has increased heat resistance. Furthermore, the reinforced thermoplastic is more impact resistant than traditional window well materials, particularly as a result of the structural features described herein. In other words, the disclosed embodiments can better resist impacts, torsion, or bending without deforming or cracking, as compared to traditional window wells. While a particular suitable material is plastic, it will be appreciated that in another embodiment, the window well having features as described herein could be formed of another material (e.g., metal).

The configuration of the described window well also adds strength and durability. For example, the ribs 230 and grooves 210 significantly increase the stiffness of the window well 100. In described, the ribs may only be visible on the backside of the window well, which typically becomes covered with soil after installation. In other words, the interior front of the window well provides a substantially flat aesthetic appearance, without any protruding ribs. This provides increased strength and durability without compromising the aesthetics of the window well.

The spacing between the grooves 210 and ribs 230 can vary to accommodate different needs and preferences (e.g., 5-10 cm), or less (e.g., 4-6 cm or less) or more (e.g., 10-12 cm or more). In some embodiments, the distance between the grooves/ribs is different within the same window well, at different locations (e.g., towards the top, versus towards the bottom). For example, one distance between the grooves/ribs may be about 5 cm, while at another location, the distance between the grooves/ribs may be 15 cm.

Additionally, as shown, the body 205 of the window well 100 includes a plurality of wall surface portions on either side of each groove 210. The wall surface portions may vary in height to accommodate different needs and preferences, from 10 cm, 20 cm, 30 cm, 40 cm, 50 cm, 60 cm or more than 60 cm. Additionally, in some embodiments, the wall surface portions follow the curvature of the body of the window well.

It should be noted that the height of the groove 210 can be defined by a greatest open latitudinal space within the groove 210 at any corresponding point in the groove 210 (i.e. the distance between the top of the groove and the bottom of the groove at the interior front surface of the window well). Similarly, the depth of the groove 210 can be defined by a greatest longitudinal distance in the groove 210, as measured from a flat surface of the window well to the most interior portion of the groove 210.

The reinforced top lip 235 increases the overall durability of the window well. In some embodiments, the reinforced top lip 235 is 20% to 100%, or 40% to 60%, or about 50% thicker than the non-reinforced portions (i.e., the substantially uniform wall thickness of about 3.5 mm). The increased thickness, as well as corrugations 237 present in the exterior rear surface of the lip greatly improve impact resistance. The corrugations provide for energy dissipation within the corrugations, associated with any such impact.

In some embodiments, the region around the attachment holes can also be reinforced. For example, in embodiments of a window well 100 with reinforced (i.e., thicker) regions that surround the attachment holes 225. The reinforced regions (i.e., the wall immediately surrounding the attachment holes 225) are 20% to 100% thicker than non-reinforced regions. Additionally, in some embodiments, the reinforced regions are 40% to 60% thicker than the non-reinforced regions and even more preferably 50% thicker. However, in some instances the reinforced regions are less than 20% thicker or more than 100% thicker than the non-reinforced regions.

In some instances, the grooves 210 vary in height and depth throughout their length and may have different dimensions as described below. In the illustrated embodiment, the grooves 210 expand from the center (i.e., the position between the two outer edges of the window well) of the groove 210 to the terminating ends of the groove 210.

This configuration can increase the strength afforded by the ribs 230 and improve the ease of molding the window wells. The variability in height of the grooves 210 may be greater than 1 mm, 2 mm, 3 mm, 4 mm, 5 mm, 6 mm or more than 6 mm, from a smallest height dimension to a greatest height dimension, of the variable height along a given groove 210 length. In some embodiments, the variability in depth may be greater than 1 mm, 2 mm, 3 mm, 4 mm, 5 mm, 6 mm or more than 6 mm, from a smallest depth dimension to a greatest depth dimension, of the variable depth along a given groove 210 length.

Varying the shape of the grooves 210 and ribs 230 in this way improves the storage stacking ability of the window wells. The wall angles of the window wells also improve the stacking ability of the window wells. Also, the integrated stacking protruding members 305 improve the stacking ability of the window wells. Lastly, the tapering of the ribs 230 and grooves 210 improves the stacking and nesting of the window wells. Such features increase the number of window wells that can be transported or stored on a single pallet, with a given degree of stability. The ribs 230 and grooves 210 can be manufactured with draft angles which prevent the window wells from binding together when stacked. Such draft angles and tapering in combination with the integrated stacking protruding members 305 facilitate easy stacking and unstacking of window wells from a pallet.

As shown, the grooves 210 include a flared portion at the terminal ends of the grooves adjacent flanges 220. More particularly, the height and the depth of the groove substantially increases at the terminal ends of the grooves (i.e. each groove expand more dramatically the last 5-10 cm of each side of the groove) as compared to the central portion of a given groove. In embodiments with flared portions, the variability in height of the grooves within the flared portions may be greater than 1 mm, 2 mm, 4 mm, 6 mm, 8 mm or more than 8 mm. Similarly, in embodiments with flared portions, the variability in depth of the grooves within the flared portions may be greater than 1 mm, 2 mm, 4 mm, 6 mm, 8 mm or more than 8 mm.

The aesthetics of the window well may also be improved by applying a texture or pattern to the surface of the window well. For example, an acid-etched texture with a horizontal grain, or a laser-etched texture with a wave pattern.

The texture can be etched onto the surface of the mold and, thereby, into the window well when the window well is molded. The texture patterns can vary to accommodate different preference and structures (e.g., horizontal grain patterns, vertical grain patterns, wave patterns, symmetrical patterns and asymmetrical patterns).

As described herein, a fabric veil can also be used to increase the realism of a texture or pattern as described in Applicant's previous patents, already incorporated by reference.

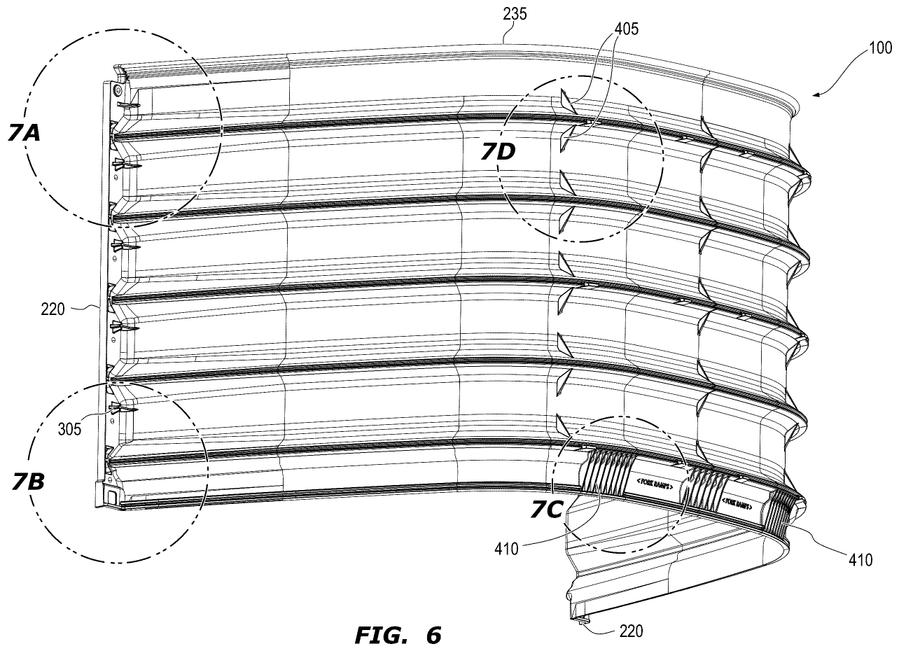

Turning now to more specific features of the window well 100, FIG. 6 illustrates window well 100 with emphasis on a mating feature (FIGS. 7A-7B) that allow attachment of one window well segment over another, to create a window well with a greater height. FIG. 7C shows a close-up of the integrated forklift supports, and FIG. 7D shows a close-up of the rib gussets.

FIG. 7A illustrates a close-up view of the mating feature 705a adjacent the top lip 235. The mating feature 705a is located at the top of the window well 100 next to the corrugated top lip 235. The mating feature 705a provides two main functions. First, the mating feature 705a gives additional strength to the window well 100 and corrugated top lip 235. The additional strength improves the impact resistance near the top lip, which is an often damaged portion of window wells as a result of impact, during transportation, storage, or installation. The corrugated top lip 235 in combination with the illustrated flange cut out 221 increases durability and impact resistance within this region.

Second, the mating feature 705a, in combination with a corresponding mating feature 705b (FIG. 7B) allows the window well 100 to mate with a second window well when stacked one on top of another. For example, the top mating feature 705a overlaps with a bottom rib mating feature 705b of another window well to create an aesthetically seamless window well structure made from multiple window well segments 100. This allows for multiple window well segments to be connected to create a single window well with greater height depending on the individual window well segments that are overlapped. Various larger window well heights may thus be possible from using one or more smaller sizes (e.g., 24 and 36 inch nominal heights), to greatly reduce the cost of associated molding equipment, and the method of manufacture. More details about the mating process will be disclosed in conjunction with FIGS. 8 through 11B.

FIG. 7B also illustrates a close-up view of the integrated stacking protruding member 305. The integrated stacking protruding member 305, as illustrated, may be a platform protruding from the flange 220, with a gusset portion 307 extending from the stacking platform 305 towards the backside of a wall portion of body 205, between ribs 230. The integrated stacking protruding member 305 may of course be of other shapes than shown.

The integrated stacking protruding member 305 is shown molded into the body of the window well 100 on the flange 220 above the attachment hole 225. In some embodiments, the integrated stacking protruding member 305 may be placed below the attachment hole 225. A plurality of such stacking protruding members are shown, with a stacking platform 305 positioned between each set of ribs 230. As shown in FIG. 3B, the integrated stacking protruding members 305 may be included on both sides of the body 205.

The integrated stacking protruding members 305 control the spacing between window wells when the window wells are stacked on a pallet. Traditionally, window wells may wedge together when stacked, making them difficult to separate. The integrated stacking protruding members 305 allow for stored stacked window wells to be far more easily separated one from another. Additionally, the integrated stacking platform 305 in combination with gusset portion 307 provide increased stiffness at the flange 220, connecting the flange to the backside of the wall portion through such gusset portion.

FIG. 7C illustrates a close-up view of one of the integrated forklift supports 410. The integrated forklift supports 410 are located at the bottom of the window well body 205, adjacent the bottom rib 230. In some embodiments, the window well 100 includes multiple integrated forklift supports 410 located at spaced apart positions below the bottom rib. The support 410 is shown as including a plurality of parallel ramp structures, for engagement with a forklift tine. Other configurations are also of course possible. The forklift supports 410 are advantageously formed during molding of the window well body 205.

The forklift supports 410 act as a ramp for engagement by forklift tines to pick up one or more of the window wells. The forklift supports 410 decrease the possibility of the tines or forks of a forklift hitting the bottom rib and causing damage.

FIG. 7D provides a close-up view of the rib gussets 405. The rib gussets 405 appear on a top side and bottom side of each rib 230. In the illustrated embodiment, each rib 230 is shown with six (three pair) associated rib gussets 405, as shown in FIG. 3B. In other embodiments, each rib 230 may have more or less associated rib gussets 405. As shown in FIG. 3B, the rib gussets 405 may be provided in the center portion of the U-shaped window well body 205, however, other placements are possible based on areas the ribs 230 need extra support from the rib gussets 405.

The rib gussets 405 prevent the ribs 230 from collapsing during the manufacturing process, when heated, during cooling. In particular, Applicant has observed that during the cooling process after molding the window well 100, the ribs 230 may collapse to some degree, like an accordion, without reinforcement. To prevent this, the rib gussets 505 add additional lateral structure to keep the ribs 230 in place during the cooling process. Additionally, the rib gussets 405 may add additional support and rigidity to the ribs 230 in general.

FIG. 8 shows a close-up view along one of the flanges, on one side of window well 100. As shown in FIG. 8, the integrated stacking protruding members 305, through gusset portion 307, extends from the flange 220 to the body 205. As mentioned above, the integrated stacking protruding member 305 and gusset portion 307 adds stiffness into the flange by tying the flange 220 into the sidewall through gusset portion 307.

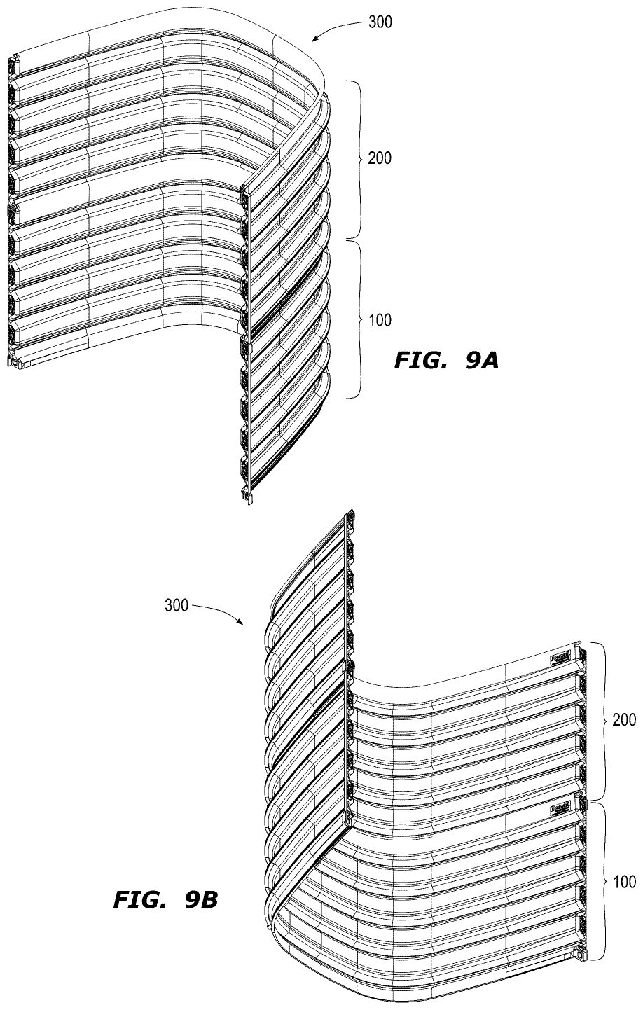

Turning now to mating multiple window wells together, FIGS. 9A through 11B show a series of steps in the process of mating a first window well with a second window well using the mating features 705a and 705b described in conjunction with FIGS. 7 and 7A-7B.

FIGS. 9A and 9B show two perspective views of two window well segments mated by the mating features 705a/705b. As shown, window well segment 100 has a mating feature 705a located at the top of the window well segment which mates with a bottom rib portion 705b of window well segment 200 creating an aesthetically seamless single window well structure 300. The overall height of the window well 300 depends on the height of window well segment 100 and window well segment 200. Window well segment 100 and window well segment 200 have the same width and footprint, however, may differ in height. In another embodiment, they may be of the same height, substantially doubling the height for the attached window well 300 as compared to either window well segment alone.

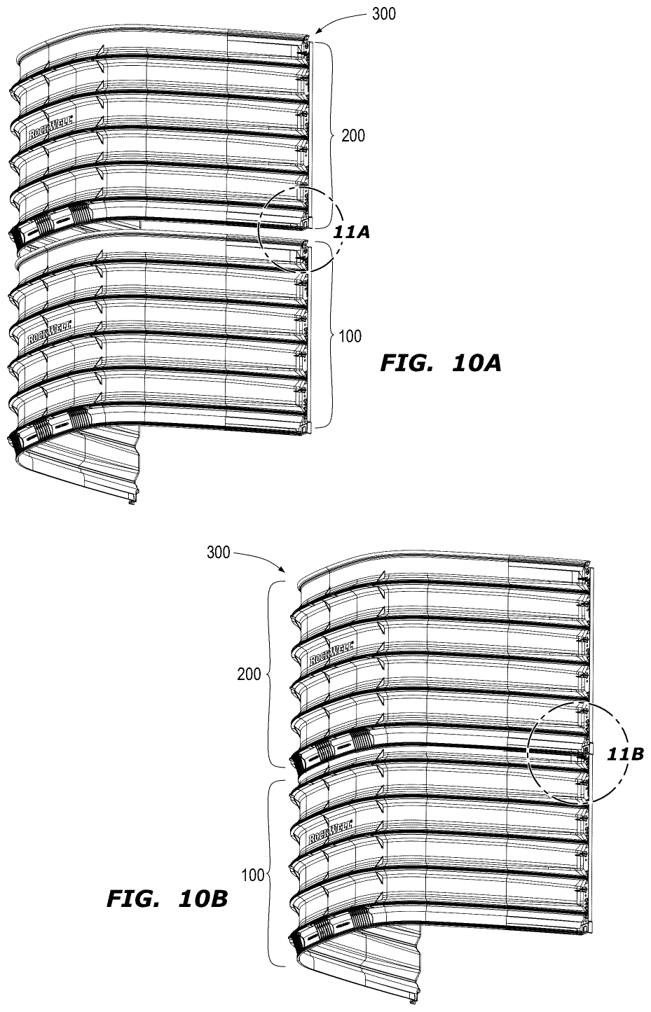

FIG. 10A illustrates window well segment 200 and window well segment 100 prior to mating and FIG. 10B illustrates window well segment 200 and window well segment 300 mated to create the window well structure 300.

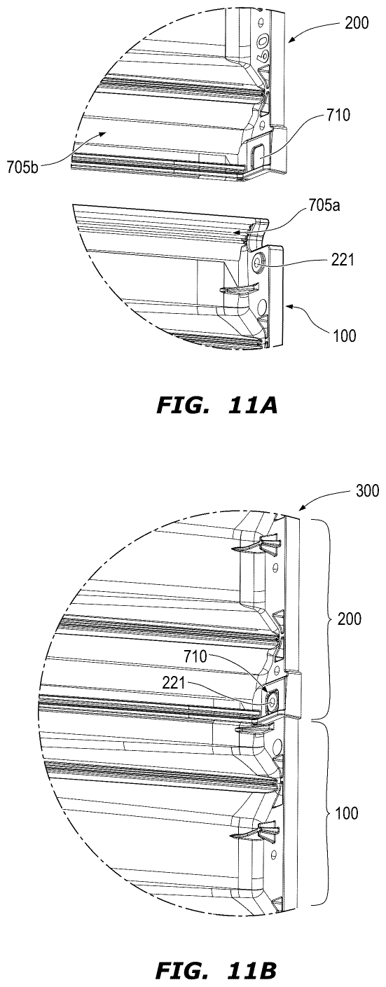

FIG. 11A illustrates a close-up view of window well segment 100 and window well 200 segment prior to mating. Window well segment 100 has a mating feature 705a while window well segment 200 has another mating feature 705b at the bottom of the window well. Mating feature 705a mates with mating feature 705b, as shown in FIG. 11B to create a single window well 300.

FIG. 12A illustrates a close-up view of the mating feature 705a and corrugated top lip 235. As shown, the mating feature 705s allows for the mating of multiple window wells (e.g., window well segment 100 mated with window well segment 200).

FIGS. 12B and 12C shows side or cross-sectional views of the window well side, where they mate together. FIG. 12D actually shows the two window well segments mated together. As illustrated, the exterior concavely curved surface of top lip 235 includes a plurality of corrugations 237. Bottom mating features 705 further include a window cutout (e.g., square or rectangle 710), which receives and engages over the circle surrounding cutout 221, at the top of the window well. Such a configuration results in the circle at the top of one window well segment being received into the square or rectangular window or hole 710 of the other window well segment, serving as a visual indicator to the user that the two segments have been properly aligned. Such may be helpful before ultrasonic welding attachment or other attachment.

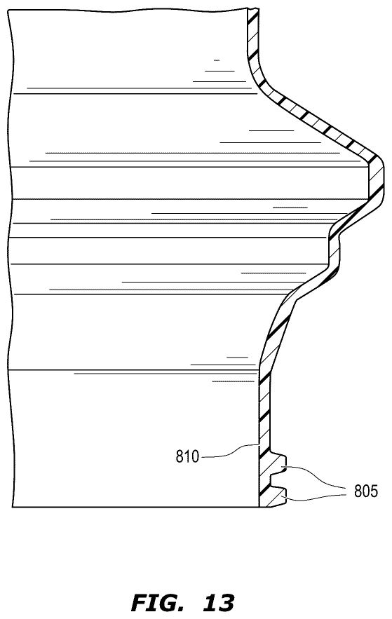

FIG. 13 illustrates the bottom exterior face of window well 100. The bottom of the window well 100 may include additional ribs 805, optionally with a notch therebetween, as shown. The additional ribs 805 in combination with flat portion 810 are designed to provide additional surface area for ultrasonic bonding or other attachment of the two segments to one another. To ultrasonically weld segments together, a flat portion 810 exists at the bottom of the window well. The flat section 810 associated with ribs 805 at the bottom of the window well may be about 0.5 inches, about 1 inch, about 1.5 inches, or about 2 inches in height, running along the length of the window well segment. Such provides sufficient surface area for ultrasonically welding the two segments together.

The additional ribs 805 are added to the flat section 810 to increase the stiffness and strength along the flat portion 810. Due to the flat portion 810 being substantially flat, it creates a vulnerable section at the bottom of the window well. As shown in FIG. 13, two ribs 805 are added, for increased strength to avoid breakage in this otherwise vulnerable location. In other embodiments, the number of additional ribs may be more or less than that shown.

### IV. Manufacturing Process for the Lightweight and Durable Window Well

As shown in FIGS. 14A-14D, the lightweight and durable window well is manufactured using a two-part mold, and one or more material charges of thermoplastic material. In some embodiments, such material charges are fiber reinforced. Additionally, in some embodiments, the molds have guide pins to ensure that the two mold portions align during compression.

In some embodiments, the molds are designed so that the window well has varying wall thickness. For example, in some embodiments the wall will be thicker in the ribbed areas and thinner in the non-ribbed areas. In other words, in some embodiments, the wall is thickest at the ribs and/or the portions of the wall near the ribs. In some instances, the wall surface portions near the ribs are thicker than parts of the wall surface portions that are furthest from the ribs, such as the wall surface portions that are centrally positioned between the ribs. The top lip is also thickened.

Described below is an exemplary method for producing the lightweight and durable window well. In the first step, fiber reinforced thermoplastic material charge(s) are heated to a relatively high temperature (e.g., greater than 130° F., greater than 150° F., greater than 180° F., greater than 200° F., greater than 225° F., greater than 250° F. and, in some instances, to above 300° F.). In some embodiments, the fiber reinforced thermoplastic material is heated to temperatures of about 385° F. or, in some embodiments, above 385° F. prior to or during the compression.

With any optional veil placed over or under the thermoplastic material charge(s), the heated material is compressed between the male mold and the female mold, as shown in FIGS. 14-16.

In some embodiments, the window wells are molded and compressed with pressures ranging from 200 psi, or about 200 psi, to 900 psi, or about 900 psi, for a duration of between 20 seconds (or about 30 seconds) and up to 90 seconds (or about 60 seconds), and even more preferably within a range of between 300 psi and 800 psi for a duration of 30-60 seconds. Additionally, in some embodiments, the pressure is between 300 psi and 400 psi. In other embodiments the pressure is less than 200 psi or more than 800 psi. The duration may also be less than 30 seconds or more than 60 seconds. The compression causes the material charge(s) to take the shape of the mold.

During molding, the male mold and/or the female mold may be heated or cooled during the molding/compressing processes. In some embodiments, the molds are heated during some parts of the molding/compressing process and cooled during other parts of the process.

While thermoplastic materials are generally described, it will be appreciated that it may also be possible to form the window well from a thermoset or other plastic material.

The window well can be deflashed/trimmed after compression to remove any excess material. The part may be molded to near net shape on all sides, to reduce or eliminate the need for such. In some embodiments, the window well coloring can be controlled by color pigments added to the plastic charge material, or the window well may be painted or otherwise coated or colored after molding.

Notwithstanding the foregoing descriptions about the benefits of thermoplastic window wells, a variety of different types of plastics, as well as non-plastic materials could be used, with similar structures and features as described.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A window well composed of a fiber reinforced plastic material, the
window well comprising:
a body having a plurality of ribs interposed between a plurality of wall surface portions, each rib being positioned between two different wall surface portions;
two or more flange portions, wherein the two or more flange portions are located at a top of the body with a first flange portion located on one side of the body and a second flange portion located on another side of the body; and
a top lip of the window well body, wherein the top lip includes a varying thickness.

2. The window well of claim 1, wherein each flange portion includes a cut-out.

3. The window well of claim 1, wherein the top lip varying thickness includes a plurality of corrugations.

4. The window well of claim 1, wherein each rib is defined by a varying height and a varying depth.

5. The window well of claim 1, wherein the body includes a varying wall thickness.

6. The window well of claim 5, wherein the varying wall thickness of the body is thicker at a peak of the ribs as compared to the wall surface portions.

7. The window well of claim 5, wherein the varying wall thickness of the body is thicker near the top lip of the window well as compared to the wall surface portions.

8. The window well of claim 1, wherein a spacing between each rib in the plurality of ribs includes a varying vertical height and each rib in the plurality of ribs includes a varying depth.

9. The window well of claim 8, wherein the varying vertical height is parallel to a major face of the body and the varying vertical height of the plurality of ribs includes a smaller height in a center of the body and a greater height at ends of the body.

10. The window well of claim 1, further comprising one or more pairs of rib gussets, wherein each pair of rib gussets is associated with and extends from a given rib.

11. The window well of claim 10, wherein the associated rib is located between a first gusset in the pair of gussets and a second gusset in the pair of gussets.

12. The window well of claim 1, further comprising one or more additional ribs located at a bottom flat portion of the body, wherein the one or more additional ribs run parallel to the plurality of ribs.

13. The window well of claim 1, further comprising a plurality of integrated stacking protruding members, wherein each integrated stacking protruding member is located on a side of the body located between sets of adjacent ribs, the integrated stacking protruding members extending from a flange of the window well.

14. The window well of claim 1, further comprising a pair of integrated forklift supports, wherein the integrated forklift supports are located so as to extend from a lower most rib of the window well, towards a bottom of the window well body, the integrated forklift supports being positioned at opposing ends of an exterior front face of the body.

15. The window well of claim 1, wherein flanges on either side of the window well are further configured with mating portions, comprising:
top mating portions, wherein the top mating portions are located on each side of a top portion of the flanges of the body; and
bottom mating portions, wherein the bottom mating portions are located on each side of a bottom portion of the flanges of the body, the bottom mating portions being configured to mate with a second top mating portion at a top portion of the flange of a second window well body.

16. A window well composed of a fiber reinforced plastic material, the window well comprising:
a body having a plurality of ribs interposed between a plurality of wall surface portions, each rib being positioned between two different wall surface portions; and
a plurality of integrated stacking protruding members, wherein each of the integrated stacking protruding members is located on a side of the body located between sets of adjacent ribs, the integrated stacking protruding members extending from a flange of the window well.

17-30. (canceled)

31. A window well composed of a fiber reinforced plastic material, the
window well comprising:
a body having flanges and a plurality of ribs interposed between a plurality of wall surface portions, each rib being positioned between two different wall surface portions;
wherein flanges on either side of the window well are configured with mating portions comprising:
top mating portions, wherein the top mating portions are located on each side of a top portion of the flanges of the body; and
bottom mating portions, wherein the bottom mating portions are located on each side of a bottom portion of the flanges of the body, the bottom mating portions being configured to mate with a second top mating portion at a top portion of the flange of a second window well body.

32-44. (canceled)

45. A method of stacking and attaching a first window well segment and a
second window well segment, the method comprising:
providing a first window well segment, wherein the first window well segment includes flanges on either side of the first window well segment, such flanges being configured with mating portions comprising:
top mating portions, wherein the top mating portions are located on each side of a top portion of the flanges of a body of the first window well segment; and
providing a second window well segment, wherein the second window well segment includes flanges on either side of the second window well segment, such flanges being configured with mating portions comprising:
bottom mating portions, wherein the bottom mating portions are located on side of a bottom portion of the flanges of a body of the second window well segment, the bottom mating portions of the second window well segment being configured to mate with the top mating portions of the first window well segment;
mating the top mating portions on the first window well segment with the bottom mating portions on the second window well segment; and
joining the first window well segment to the second window well segment.

46. The method of claim 45, wherein the method further comprises fastening the first window well segment to the second window well segment with a fastener in addition to the welding.

47. (canceled)

48. A method of manufacturing a window well that is structured to provide improved aesthetics and window well properties, the method comprising:
heating a mold to a temperature of greater than 130° F.;
positioning a charge of a fiber reinforced plastic material within the mold;
compressing the fiber reinforced plastic material within the mold with a pressure of greater than 200 psi.

49. (canceled)
